(19) United States
(12) Patent Application Publication
(10) Pub. No.: US 2023/0146731 A1
(43) Pub. Date: May 11, 2023

(54) Heating Device with Detachable Collection Container

(71) Applicants: Sohel Dahi, Jacksonville, FL (US); Jason Zedan, Jacksonville, FL (US); Michael Chahda, Jacksonville, FL (US)

(72) Inventors: Sohel Dahi, Jacksonville, FL (US); Jason Zedan, Jacksonville, FL (US); Michael Chahda, Jacksonville, FL (US)

(21) Appl. No.: 17/981,419

(22) Filed: Nov. 5, 2022

Related U.S. Application Data
(60) Provisional application No. 63/276,049, filed on Nov. 5, 2021.

(51) Int. Cl. F27B 9/24; B65G 47/24

(52) U.S. Cl. CPC F27B 9/24; B65G 47/24

(57) ABSTRACT

The present disclosure provides for a heating device. The heating device may comprise one or more transitory mechanisms. Each transitory mechanism may rotate, elevate, and/or otherwise manipulate the orientation of one or more heated objects to ensure even heat distribution and consistent cyclical movement through the heating device. The heating device may comprise a heating container. The heating container may at least partially enclose the heated objects for the duration of the heating process to ensure even heating of the heated objects. The heating device may comprise one or more heating elements. The heating elements may warm the heated objects to a predetermined temperature in preparation for the final heating within the heating container to reduce the required heating time within the heating container. The heating device may comprise one or more collecting mechanisms. The heating device may comprise a dispensing mechanism.

### CROSS-REFERENCE TO RELATED APPLICATION

This application is a Non-provisional of and claims priority to U.S. Provisional Patent Application Ser. No. 63/276,049 (filed Nov. 5, 2021, and titled “HEATING DEVICE WITH DETACHABLE COLLECTION CONTAINER”), the entire contents of which are incorporated herein by reference.

### BACKGROUND

Centuries ago, in ancient Persia and India, people discovered an alternative method for using tobacco. Although this method has been referred to by many names over the years, one of modern society's common names for the method is hookah. A hookah typically consists of a water pipe with a smoke chamber, a bowl, a pipe, and a hose. Special tobacco is heated, and the smoke from the burned tobacco passes through the water and is drawn through the rubber hose to a mouthpiece.

Today, there are many different brands, shapes, and styles of hookah charcoals available on the market. Fundamentally, the hookah charcoal is the heat source that cooks the tobacco within the hookah to produce smoke. Once the charcoals are lit, they are placed on top of the hookah bowl and the heat the charcoal produces cooks the tobacco and produces the intended smoke. However, there are currently few options for heating the charcoals that result in the charcoals being heated evenly.

In the current market, there are many charcoal heaters available that are specifically designed to heat charcoal for hookahs. The heating process is similar to the heating of an electric stovetop. After being activated, a heater can reach high temperatures to heat charcoal. Unfortunately, similar to cooking on a stovetop, only the surface of the heater that is in direct contact with the charcoal provides significant heating.

This inefficiency requires that the charcoals be rotated manually until all sides of the charcoal are heated evenly. The manual process of rotating the charcoal causes the heating process to take time and demand constant attention. What is needed is a heating device that evenly heats the multiple sides of the charcoal simultaneously.

### SUMMARY OF THE DISCLOSURE

The present disclosure provides for a heating device that evenly heats the multiple sides of one or more pieces or units of charcoal simultaneously. By heating the charcoal evenly, the heating device may provide a simpler and less demanding interaction for a user. Additionally, heating multiple sides of the charcoal simultaneously removes the extra time and attention required to flip the charcoal and may allow users to heat the charcoal at a faster rate.

The heating device may comprise one or more transitory mechanisms. The transitory mechanism may rotate, elevate, and otherwise manipulate the orientation of one or more heated objects to ensure even heat distribution and consistent cyclical movement through the heating device. The heating device may comprise at least one heating container. The heating container may at least partially enclose one or more heated objects therein for the duration of the heating process to ensure even heating of the heated objects. The heating device may comprise one or more heating elements. The heating elements may warm the heated objects to a predetermined temperature in preparation for a final heating within the heating container to reduce the required heating time within the heating container. The heating device may comprise one or more collection containers. The heating device may comprise at least one dispensing mechanism.

The present disclosure relates to a heating device comprising a heating container; a heating element configured to heat at least one heated object, such as charcoal, wherein the heating element is located within the heating container; a first transitory mechanism comprising a movable platform configured to move the at least one heated object to at least one position proximate to the heating element for a predefined amount of time, measured and monitored by a controller with a timing device, allowing the at least one heated object to reach at least a predefined temperature; and an activation mechanism logically connected to one or more of the heating element and the first transitory mechanism, wherein the activation mechanism is configured to operate one or more of: the heating element and the first transitory mechanism.

In some aspects, the first transitory mechanism is further configured to move the at least one heated object to a location away from the heating element, once the at least one heated object has reached at least the predefined temperature. In some embodiments, the first transitory mechanism rotates. In some implementations, a second transitory mechanism is located proximate to one or both the heating element and the first transitory mechanism, wherein the second transitory mechanism is configured to receive and move the at least one heated object to a location away from the heating element, once the at least one heated object has reached at least the predefined temperature.

In some embodiments, a third transitory mechanism is located between the first transitory mechanism and the second transitory mechanism, wherein the third transitory mechanism is configured to move the at least one heated object through the heating container for a duration that allows the at least one heated object to reach at least the predefined temperature. In some implementations, the third transitory mechanism rotates. In some aspects, the heating container further comprises a ventilation system comprising at least one opening.

In some embodiments, the heating device further comprises at least one collecting mechanism configured to collect a plurality of heated objects. In some aspects, the at least one collecting mechanism is removable. In some implementations, the transitory mechanism deposits the heated objects into the at least collecting mechanism. In some aspects, the heating device may further comprise a first door and a second door that may be configured to at least temporarily enclose the heating container, wherein the first door opens and shuts when a heated object enters the heating container, and the second door opens and shuts when the heated object exits the heating container.

In some implementations, the heating device may further comprise at least one dispensing mechanism comprising an outlet that dispenses heated objects onto the first transitory mechanism. In some embodiments, the dispensing mechanism dispenses the heated objects at a constant rate, such as may be dictated by a controller with a timing device. In some aspects, the dispensing mechanism may further comprise at least one sensor logically connected to a regulator that controls a speed at which the heated objects are dispensed.

In some embodiments, the first transitory mechanism manipulates the orientation of a plurality of heated objects by one or more of: elevating, rotating, and moving the plurality of heated objects. In some implementations, at least a portion of the first transitory mechanism elevates one or more heated objects toward the heating element until a predefined temperature is reached as verified by at least one thermometer or similar temperature sensor, then lowers said one or more heated objects. In some aspects, the heating device may further comprise at least one external device that is communicatively coupled with the activation mechanism.

In some implementations, the heating device may further comprise a rechargeable power source in logical communication with the activation mechanism. In some embodiments, the heating element rotates within the heating container. In some aspects, the heating element may be raised and lowered within the heating container.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary heating device, according to some embodiments of the present disclosure.

FIG. 1B illustrates an exemplary heating device, according to some embodiments of the present disclosure.

FIG. 2A illustrates an exemplary heating device, according to some embodiments of the present disclosure.

FIG. 2B illustrates an exemplary heating device, according to some embodiments of the present disclosure.

FIG. 3A illustrates an exemplary heating device comprising a dispensing mechanism, according to some embodiments of the present disclosure.

FIG. 3B illustrates an exemplary heating device comprising a dispensing mechanism, according to some embodiments of the present disclosure.

FIG. 4A illustrates an exemplary heating device comprising a plurality of collection containers, according to some embodiments of the present disclosure.

FIG. 4B illustrates an exemplary heating device comprising a plurality of collection containers, according to some embodiments of the present disclosure.

FIG. 5A illustrates an exemplary heating device comprising a plurality of heating elements, according to some embodiments of the present disclosure.

FIG. 5B illustrates an exemplary heating device comprising a plurality of heating elements, according to some embodiments of the present disclosure.

FIG. 6A illustrates an exemplary heating device comprising a plurality of transitory mechanisms, according to some embodiments of the present disclosure.

FIG. 6B illustrates an exemplary heating device comprising a plurality of transitory mechanisms, according to some embodiments of the present disclosure.

FIG. 6C illustrates an exemplary heating device comprising a plurality of transitory mechanisms, according to some embodiments of the present disclosure.

FIG. 7 illustrates an exemplary heating device comprising a plurality of transitory mechanisms, according to some embodiments of the present disclosure.

FIG. 8A illustrates an exemplary heating device interacting with an external device, according to some embodiments of the present disclosure.

FIG. 8B illustrates an exemplary heating device interacting with an external device, according to some embodiments of the present disclosure.

FIG. 9 illustrates an exemplary heating device comprising a plurality of transitory mechanisms, according to some embodiments of the present disclosure.

FIG. 10 illustrates an exemplary heating device comprising a plurality of transitory mechanisms, according to some embodiments of the present disclosure.

FIG. 11A illustrates an exemplary heating device comprising a moving heating element, according to some embodiments of the present disclosure.

FIG. 11B illustrates an exemplary heating device comprising a moving heating element, according to some embodiments of the present disclosure.

FIG. 11C illustrates an exemplary heating device comprising a moving heating element, according to some embodiments of the present disclosure.

FIG. 12 illustrates an exemplary heating device comprising a plurality of transitory mechanisms, according to some embodiments of the present disclosure.

### DETAILED DESCRIPTION

The present disclosure provides generally for a heating device that evenly heats the multiple sides of one or more heated objects simultaneously. According to the present disclosure, the heating device may comprise at least one heating container. In some embodiments, the heating container may at least partially enclose the heated objects therein for the duration of the heating process to ensure even heating of the heated objects. In some implementations, the heating device may comprise one or more heating elements. In some aspects, the heating elements may warm the heated objects to a predetermined temperature in preparation for a final heating within the heating container to reduce the required heating time within the heating container.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Heated object: as used herein refers to any object that may be subjected to heating. In some embodiments, a plurality of heated objects may be heated simultaneously. In some implementations, the heated objects may be heated in predetermined quantities. In some aspects, the heated objects may comprise a material that allows for retention of the heat infused into the heated objects by a heating device, such as charcoal, as a non-limiting example. In some embodiments, a heated object may be referred to as charcoal for ease of reference but should not be limited to such.
Heating device: as used herein refers to a device that may comprise a plurality of components that facilitate cyclical heating of heated objects. In some embodiments, the heating device may comprise one or more transitory mechanisms that may provide autonomous or cyclic movement, or both, to and from the heating container within the heating device. In some implementations, the heating device may interface with one or more removable components, such as one or more collecting mechanisms, such as, for example and not limitation, one or more collection containers, that may facilitate the removal of heated objects after heating is completed.

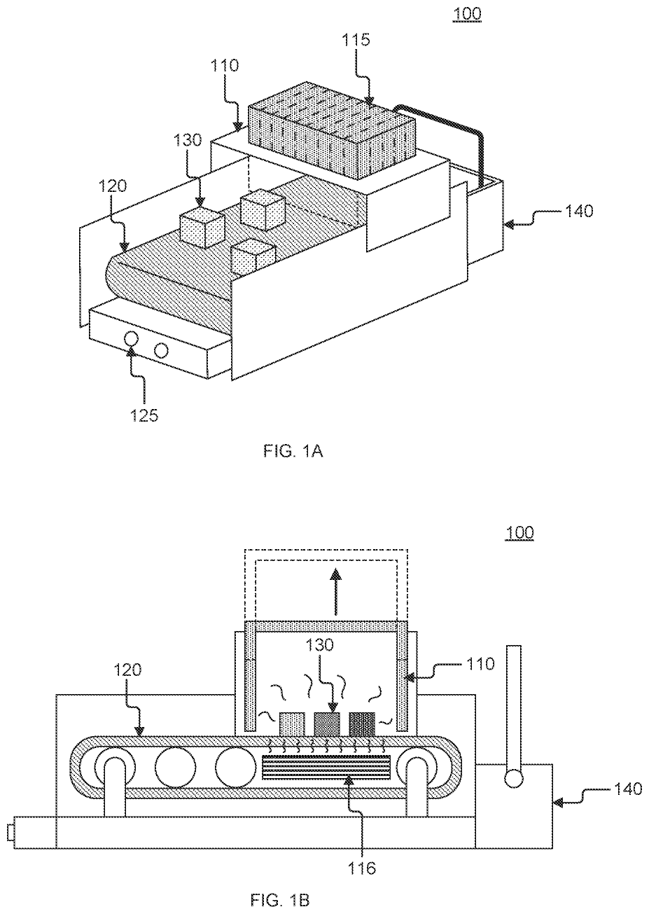

Referring now to FIGS. 1A-B, an exemplary heating device 100 is illustrated. In some embodiments, the heating device 100 may comprise a heating container 110. In some implementations, the heating container 110 may comprise a heating element 115. In some aspects, the heating device 100 may comprise a transitory mechanism 120.

In some embodiments, the transitory mechanism 120 may transport one or more heated objects 130 to the heating container 110. In some aspects, the transitory mechanism 120 may reduce the need for manual insertion of heated objects 130 into the heating container 110. In some embodiments, the heating container 110 may provide an at least partial enclosure sufficient to provide heating to all sides of the heated objects 130 simultaneously.

In some implementations, the transitory mechanism 120 may move based on input received from at least one activation mechanism 125. In some embodiments, the activation mechanism 125 may activate a cyclical movement of the transitory mechanism to allow heated objects 130 within the heating container 110 sufficient time to reach a predetermined temperature. In some aspects, the transitory mechanism 120 may deposit heated objects 130 into a collecting mechanism, such as, for example and not limitation, a collection container 140, for use when the heated objects 130 have reached the predetermined temperature.

As an illustrative example, some charcoal may be placed upon conveyor belt that, upon activation, moves the charcoal until it is directly beneath a heated cover. As the charcoal reaches this point, the conveyor belt may pause while the heated cover lowers and at least partially encloses the charcoal. Heated coils may warm the charcoal within the heated cover while the walls of the heated cover ensure an even heating on all sides of the charcoal. After being heated, the heated cover may retract and the conveyor belt may continue to move the charcoal until the charcoal dispenses into a collecting mechanism in the form of a bucket. In some implementations, the collecting mechanism may be removable.

In some embodiments, the transitory mechanism 120 may operate at discrete intervals. For example, the transitory mechanism 120 may stop for predetermined periods of time periodically. In some aspects, the heating container 110 may comprise a ventilation system, whereby the heated objects 130 may be subject to convection heating. In some embodiments, the heating element 115 may provide heat via electrical induction. In some implementations, the heating container 110 may comprise a plurality of heating elements 115, 116 that may provide more even heat distribution to all sides of the heated objects 130 simultaneously.

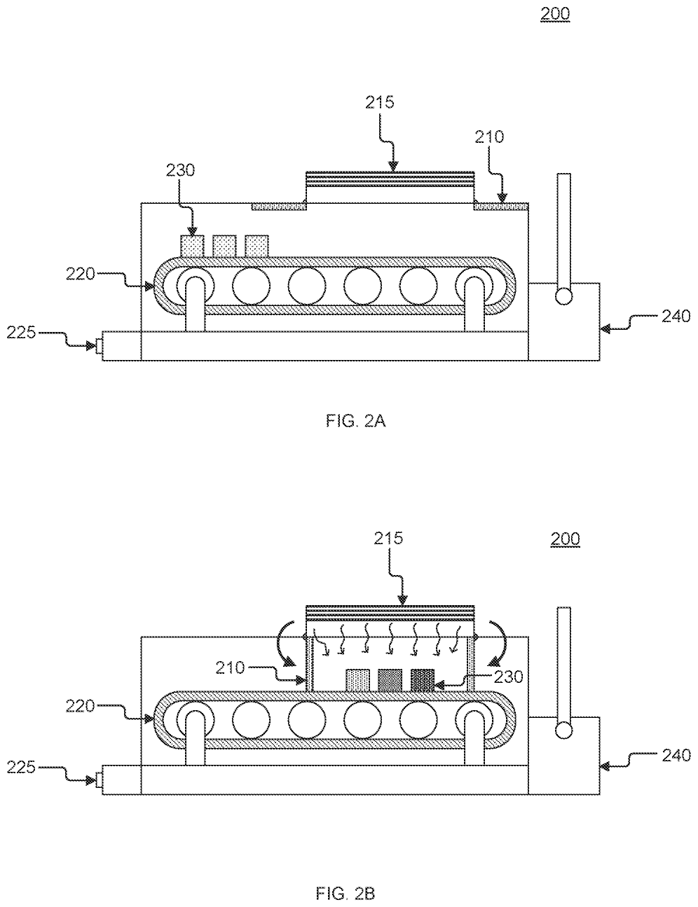

Referring now to FIGS. 2A-B, an exemplary heating device 200 is illustrated. In some embodiments, the heating device 200 may comprise a heating container 210. In some implementations, the heating container 210 may comprise a heating element 215. In some aspects, the heating device 200 may comprise a transitory mechanism 220.

In some embodiments, the transitory mechanism 220 may transport one or more heated objects 230 to the heating container 210. In some implementations, the transitory mechanism may move based on input received from at least one activation mechanism 225. In some aspects, the transitory mechanism 220 may deposit heated objects 230 into a collecting mechanism, such as, for example and not limitation, a collection container 240, for use when the heated objects 230 have reached the predetermined temperature.

In some embodiments, the heating container 210 may remain in a fixed position. In some implementations, the heating container 210 may comprise one or more entryways that open and shut to enclose heated objects 230 when they are centered within the heating container 210. As an example, a conveyor belt may stop moving heated objects 230 in the form of charcoal when they are positioned directly beneath the heating element 215 within the heating container 210. Small doors may block both directions of motion on the conveyor belt to at least partially enclose the heated objects 230 for more efficient and even heating to all sides of the charcoal.

The fixed nature of the heating container 210 may allow the heating device 200 to heat a large quantity of heated objects 230 in an efficient manner due to being able to at least partially enclose the heated objects 230 quickly with closing walls rather than moving the entire heating container 210. In some embodiments, the heated objects 230 may heat more quickly than traditional heating methods because the even heat distribution on all sides of the charcoal removes the need to rotate the heated objects 230.

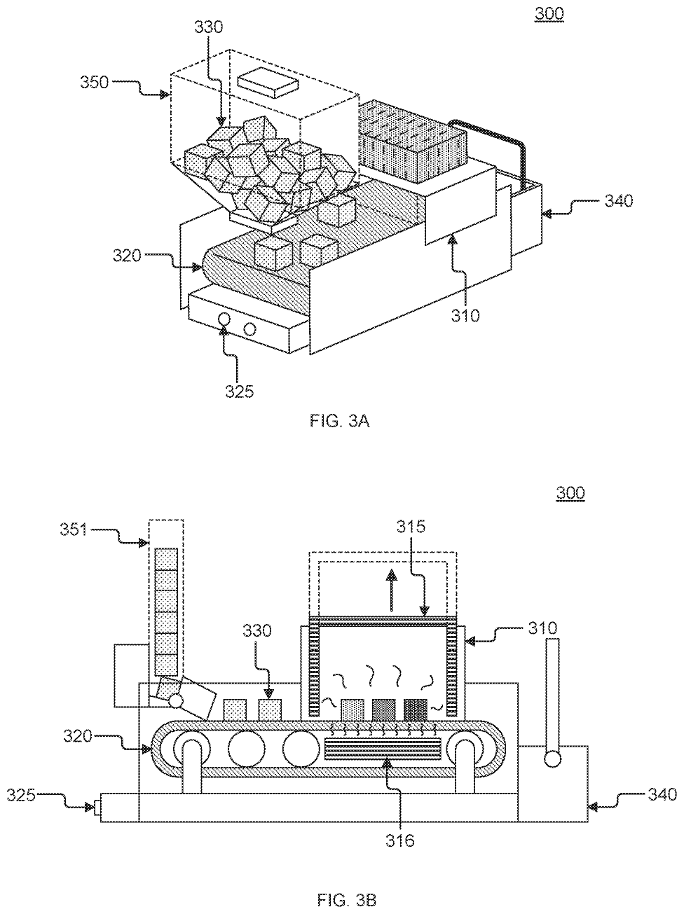

Referring now to FIGS. 3A-B, an exemplary heating device 300 comprising a dispensing mechanism 350, 351 is illustrated. In some embodiments, the heating device 300 may comprise a heating container 310. In some implementations, the heating container 310 may comprise one or more heating elements 315, 316. In some aspects, the heating device 300 may comprise a transitory mechanism 320. In some embodiments, the transitory mechanism 320 may transport one or more heated objects 330 to the heating container 310.

In some aspects, the transitory mechanism 320 may receive the heated objects 330 from a dispensing mechanism 350, 351. In some embodiments, the dispensing mechanism 350 may allow the heating device 300 to process heated objects 330 at a continuous rate. In some implementations, the dispensing mechanism 351 may comprise a narrow dispensing outlet for the heated objects 330.

In some aspects, the dispensing mechanism 350, 351 may comprise at least one sensor logically connected to a regulator that controls the dispensing speed or rate of heated objects 330 onto the transitory mechanism 320. In some embodiments, the regulation of heated objects 330 may allow the heating device 300 to ensure that there are at least as few heated objects 330 in the heating container 310 as the heating element 315 can sufficiently heat simultaneously.

In some implementations, the transitory mechanism 320 may move based on input received from at least one activation mechanism 325. In some aspects, the activation mechanism 325 may interface with the dispensing mechanism 351. In some embodiments, the cycle of movement instigated by the activation mechanism 325 may be regulated by the number of heated objects 330 dispensed in a predetermined quantity of time. In some aspects, the transitory mechanism 320 may deposit heated objects 330 into a collecting mechanism, such as, for example and not limitation, a collection container 340, for use when the heated objects 330 have reached the predetermined temperature.

In some embodiments, the heating container 310 may comprise one or more heating elements 315, 316. In some implementations, the plurality of heating elements 315, 316 may at least partially encircle the heated objects 330 to provide distributed heating to the heated objects 330. In some aspects, the heating element 315 may conform to the heating container 310, such as heated coils in the walls of a heating lid that at least partially encloses charcoal bricks, as a non-limiting example.

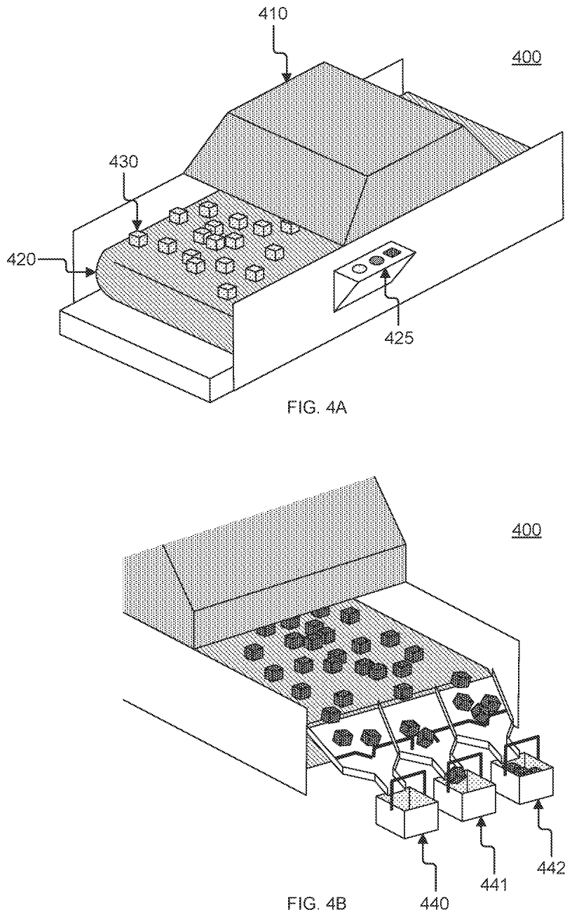

Referring now to FIGS. 4A-B, an exemplary heating device 400 comprising a plurality of collecting mechanisms in the form of collection containers is illustrated. In some embodiments, the heating device 400 may comprise a heating container 410. In some aspects, the heating device 400 may comprise a transitory mechanism 420.

In some embodiments, the transitory mechanism 420 may transport a plurality of heated objects 430 to the heating container 410 to be heated simultaneously. In some implementations, the transitory mechanism 420 may move based on input received from at least one activation mechanism 425. In some embodiments, a heating element may be placed beneath or above the heated objects 430, as non-limiting options, to provide even heat distribution to the heated objects 430.

In some aspects, the transitory mechanism 420 may deposit heated objects 430 into a plurality of collecting mechanisms, such as, by way of example and not limitation, collection containers 440, 441, 442, for use when the heated objects 430 have reached the predetermined temperature. In some implementations, the collection containers 440, 441, 442 may be removable. In some embodiments, the transitory mechanism 420 may comprise a counting mechanism that enables the transitory mechanism 420 to direct heated objects 430 to specific collection containers 440, 441, 442.

As an illustrative example, a mechanical lever may direct all heated charcoal from the transitory mechanism 420 to a first collection container 440 until the collection container 440 notifies the heating device 400 that its threshold has been met. The mechanical level may then redirect charcoal on the conveyor belt to a second collection container 441.

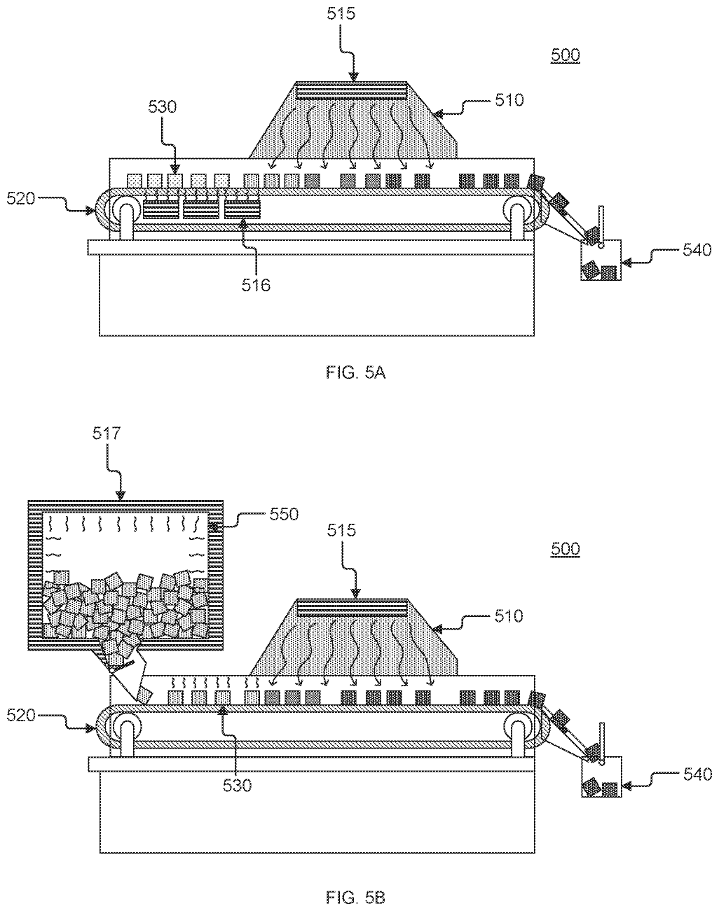

Referring now to FIGS. 5A-B, an exemplary heating device 500 comprising a plurality of heating elements 515, 516 is illustrated. In some embodiments, the heating device 500 may comprise a heating container 510. In some implementations, the heating device 500 may comprise one or more heating elements 515, 516.

In some aspects, the heating device 500 may comprise a transitory mechanism 520. In some embodiments, the transitory mechanism 520 may transport one or more heated objects 530 to the heating container 510. In some implementations, the transitory mechanism 520 may comprise one or more heating elements 516 to shorten the required time for the heated objects 530 to remain within the heating container 510 to reach a predetermined temperature.

In some aspects, the transitory mechanism 520 may receive the heated objects 530 from a dispensing mechanism 550. In some embodiments, the dispensing mechanism 550 may comprise one or more heating elements 517. In some aspects, the heating elements 517 may shorten the required time for the heated objects 530 to remain within the heating container 510 to reach a predetermined temperature. In some embodiments, the heating elements 517 may reduce the required heating time by evenly heating all sides of the heated objects 530 simultaneously.

In some implementations, the transitory mechanism 520 may move based on input received from at least one activation mechanism. In some embodiments, the activation mechanism may activate a cyclical movement of the transitory mechanism 520 to allow heated objects 530 within the heating container 510 sufficient time to reach a predetermined temperature. In some aspects, the transitory mechanism 520 may deposit heated objects 530 into a collecting mechanism, such as, for example and not limitation, a collection container 540, for use when the heated objects 530 have reached the predetermined temperature.

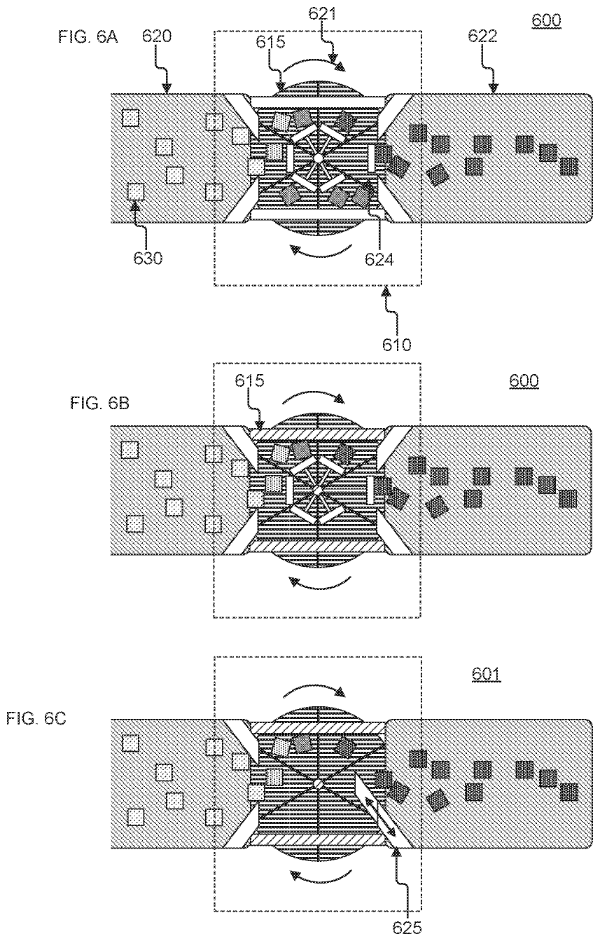

Referring now to FIGS. 6A-6C, an exemplary heating device 600, 601 comprising a plurality of transitory mechanisms 620, 621, 622 is illustrated. In some embodiments, the heating device 600, 601 may comprise a heating container 610. In some aspects, the heating device 600, 601 may comprise a plurality of transitory mechanisms 620, 621, 622.

In some embodiments, the transitory mechanism 620 may linearly transport one or more heated objects 630 to the heating container 610 with at least one heating element 615. In some implementations, the transitory mechanism 621 may rotate, elevate, and/or otherwise manipulate the orientation of the heated objects 630 to ensure even heat distribution on all sides of the heated objects 630 simultaneously, as well as maintain consistent cyclical movement through the heating device 600.

As an illustrative example, charcoal may be transported linearly to the entrance of the heating container 610, where the charcoal may then be funneled onto a portion of a rotating platform. The rotating platform may rotate at a rate sufficient to allow the charcoal to be heated to the predetermined temperature by the heating element 615. As the charcoal reaches the end region of the heating container 610, a mechanical arm or similar mechanism may push the charcoal from the rotating platform onto a final linear conveyor belt. In some aspects, the transitory mechanism 622 may deposit heated objects 630 into a collecting mechanism, such as, for example and not limitation, a collection container, for use when the heated objects 630 have reached the predetermined temperature.

In some aspects, a releasing mechanism 624, 625 may move the heated objects 630 from the heating element 615 to the transitory mechanism 622. From there, the heated objects 630, which are now hot, may be removed for use. In some aspects, the heating element 615 may periodically turn on and off to maintain a steady temperature within the heating container 610. In some aspects, the releasing mechanism 624, 625 may be at least partially automatic in operation and may continuously push thoroughly heated objects 630 to the transitory mechanism 622 at regular time intervals or when certain temperatures are detected by one or more temperature sensors, as interpreted and directed by at least one controller, such as a computer processor.

In some embodiments, the releasing mechanism 624, 625 may comprise sensing or smart features, wherein heated objects 630 may be pushed onto the transitory mechanism 622 when they reach a predetermined temperature as detected and determined by at least one controller communicatively coupled to, either wirelessly or via one or more wired connections, at least one temperature sensing device.

In some implementations, heated objects 630 may be held within the heating container 610 and rotated to receive an even temperature. Once the heated objects 630 reach a predefined temperature, the heating container 610 may open, thereby allowing the heated objects 630 to exit and cool heated objects 630 to enter. In some embodiments, a rotating transitory mechanism 621 may rotate the heated objects 630, wherein a predefined number of rotations may cause the heated objects 630 to reach a predefined temperature. In some aspects, the transition of the heated objects 630 into and out of the heating container 610 may be continuous.

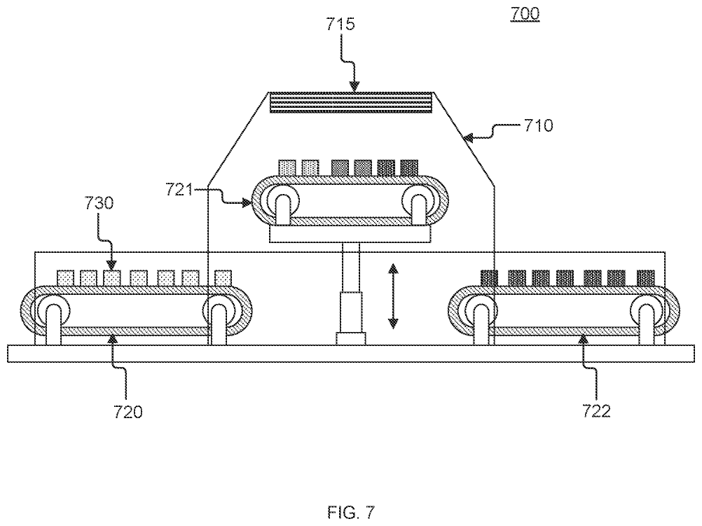

Referring now to FIG. 7, an exemplary heating device 700 comprising a plurality of transitory mechanisms 720, 721, 722 is illustrated. In some embodiments, the heating device 700 may comprise a heating container 710. In some implementations, the heating container 710 may comprise a heating element 715. In some aspects, the heating device 700 may comprise one or more transitory mechanisms 720, 721, 722.

In some embodiments, the transitory mechanism 720 may transport the heated objects 730 to the heating container 710. In some implementations, the transitory mechanism 721 may rotate, elevate, and/or otherwise manipulate the orientation of the heated objects 730 to ensure even heat distribution and consistent cyclical movement through the heating device 700. As an illustrative example, a heating device 700 may comprise three conveyor belts. The first conveyor belt may receive the heated objects 730 and bring them to the entrance of the heating container 710. The heated objects 730 may reach the center of the heating container 710 via the second conveyor belt.

The second conveyor belt may elevate the heated objects 730 to increase proximity to the heating element 715. After the heated objects 730 have reached a predetermined temperature, the second conveyor belt may lower and transfer the heated objects 730 to a third conveyor belt. In some aspects, the transitory mechanism 722 may deposit heated objects 730 into a collecting mechanism, such as, for example and not limitation, a collection container, when the heated objects 730 have reached the predetermined temperature.

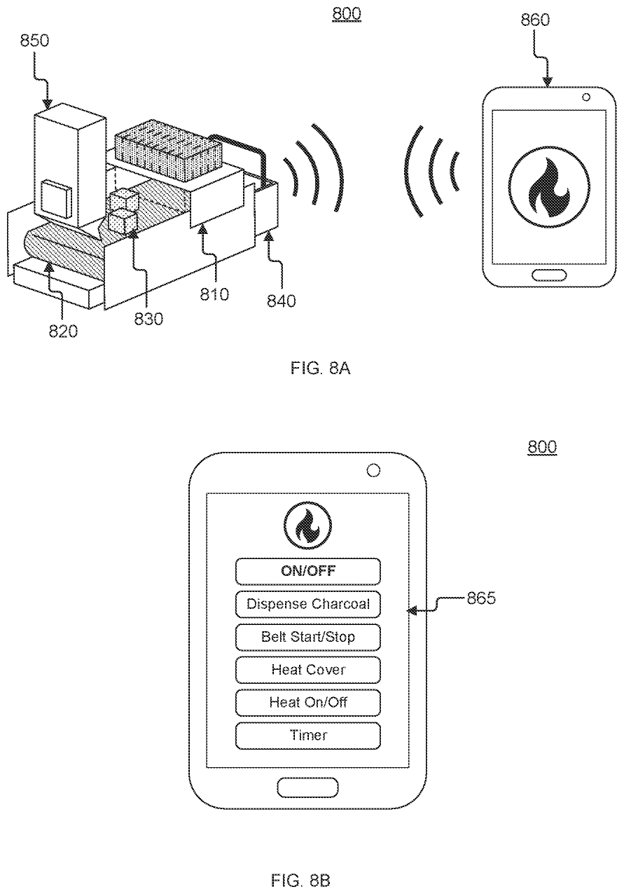

Referring now to FIGS. 8A-B, an exemplary heating device 800 interacting with an external device 860 is illustrated. In some embodiments, the heating device 800 may comprise a heating container 810. In some implementations, the heating container 810 may comprise a heating element. In some aspects, the heating device 800 may comprise a transitory mechanism 820. In some implementations, a dispensing mechanism 850 may place heated objects 830 on the transitory mechanism 820.

In some embodiments, the transitory mechanism 820 may transport one or more heated objects 830 to the heating container 810. In some implementations, the transitory mechanism 820 may move based on input received from at least one activation mechanism. In some aspects, the transitory mechanism 820 may deposit heated objects 830 into a collecting mechanism, such as, for example and not limitation, a collection container 840, for use when the heated objects 830 have reached the predetermined temperature. In some embodiments, the activation mechanism or heating device, or both, may interface with at least one external device 860, such as a laptop computing device, a desktop computing device, a tablet computing device, or a smartphone, as non-limiting examples.

In some implementations, the heating device 800 may comprise one or more at least partially automated components that may activate when a signal is received from the external device 860. For example, the heating device 800 may exist in a suspended state until the external device 860 activates the heating device 800 remotely. As another example, the dispensing mechanism 850 may dispense a predetermined number of heated objects 830 when actuated by a signal received from the external device 860. The transitory mechanism 820 may subsequently activate to begin the heating process when directed by the external device 860.

In some aspects, the external device 860 may comprise at least one user interface 865. In some embodiments, the user interface 865 may provide remote operative capabilities. In some implementations, the user interface 865 may allow a user to dispense heated objects 830, activate the heating device 800, start and stop the transitory mechanism 820, lower the heating container 810, activate or deactivate the heating element, or set a timer, as non-limiting examples.

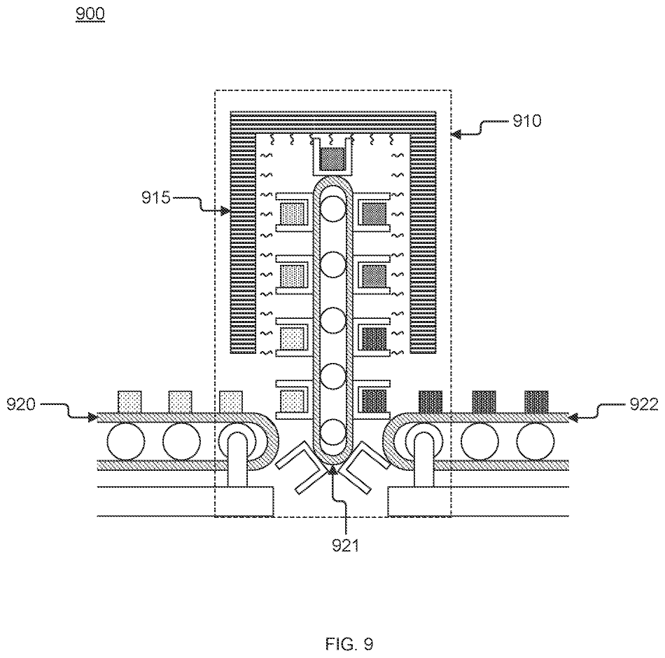

Referring now to FIG. 9, an exemplary heating device 900 comprising a plurality of transitory mechanisms 920, 921, 922 is illustrated. In some embodiments, the heating device 900 may comprise a heating container 910. In some implementations, the heating container 910 may comprise a heating element 915. In some aspects, the heating device 900 may comprise a plurality of transitory mechanisms 920, 921, 922.

In some embodiments, the transitory mechanism 920 may linearly transport one or more heated objects 930 to the heating container 910 with at least one heating element 915. In some implementations, upon reaching the heating container 910, each heated object 930 may be removably secured within a gripping or grasping mechanism, such as a clamp, clasp, claw, or slot, as non-limiting examples. This may allow the heated objects 930 to be carried upwardly along a vertically-oriented transitory mechanism 921 while remaining in continuous close proximity to the heating element 915. In some aspects, each gripping or grasping mechanism may be spring based. In some embodiments, heated objects 930 may be carried away from the heating container 910 by a horizontally-oriented transitory mechanism 922 after the heated objects 930 have obtained at least a predefined temperature.

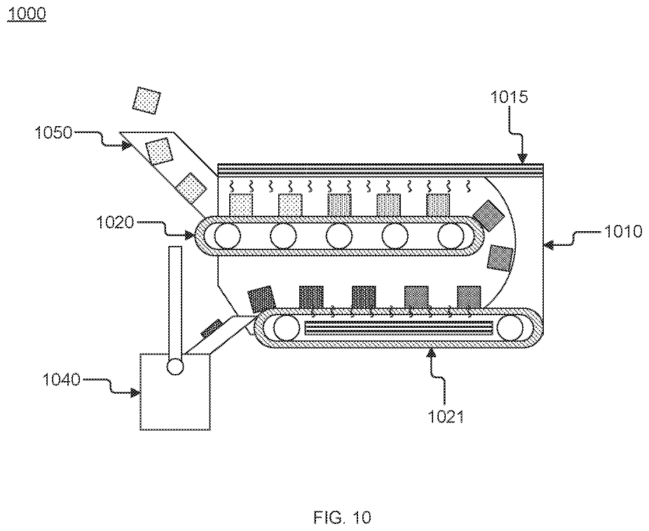

Referring now to FIG. 10, an exemplary heating device 1000 comprising a plurality of transitory mechanisms 1020, 1021 is illustrated. In some embodiments, a dispensing mechanism 1050 may deposit one or more heated objects 1030 onto a first transitory mechanism 1020, which may pass through a heating container 1010 that comprises at least one heating element 1015. The warmed heated objects 1030 may subsequently drop onto a second transitory mechanism 1021, which may continue to pass the heated objects 1030 through the heating container 1010 until the heated objects 1030 reach at least a predefined temperature. From there, the heated objects 1030 may drop into a collecting mechanism, such as, for example and not limitation, a collection container 1040.

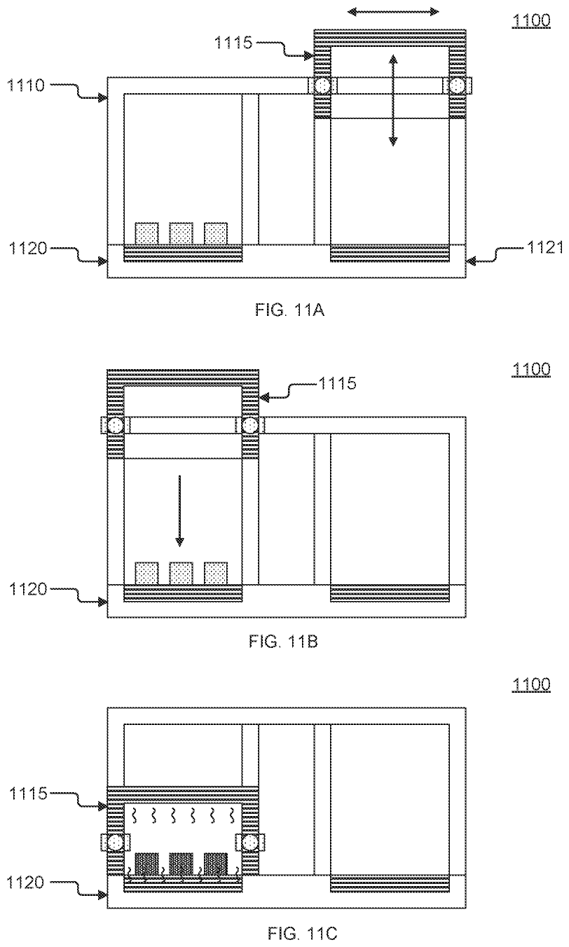

Referring now to FIGS. 11A-11C, an exemplary heating device 1100 comprising a moving heating element 1115 s illustrated. In some embodiments, the heating device 1100 may comprise a heating container 1110. In some implementations, the heating container 1110 may comprise a heating element 1115. In some aspects, the heating device 1100 may comprise a transitory mechanism 1120, 1121.

In some embodiments, the heated objects 1130 may be placed in a first side of the heating device 1100. In some implementations, the heating element 1115 may move horizontally along a top portion of the heating device 1100, such as along a track, as a non-limiting example. In some aspects, the heating element 1115 may also move vertically, such as along a second track or similar structure, within the heating device 1100 to cover and heat the heated objects 1130 with increased proximity thereto. In some embodiments, the heating container 1110 may provide an at least partial enclosure sufficient to provide heating to all sides of the heated objects 1130 simultaneously.

As an illustrative example, charcoal may be placed within a heating device 1100, and the heating element 1115 may be in a different section of the heating device 1100. The heating element 1115, may thus be movable along one or more tracks or similar structures, thereby allowing the heating element 1115 to move to a position over the charcoal, then descend vertically to at least partially enclose and thereby heat the charcoal.

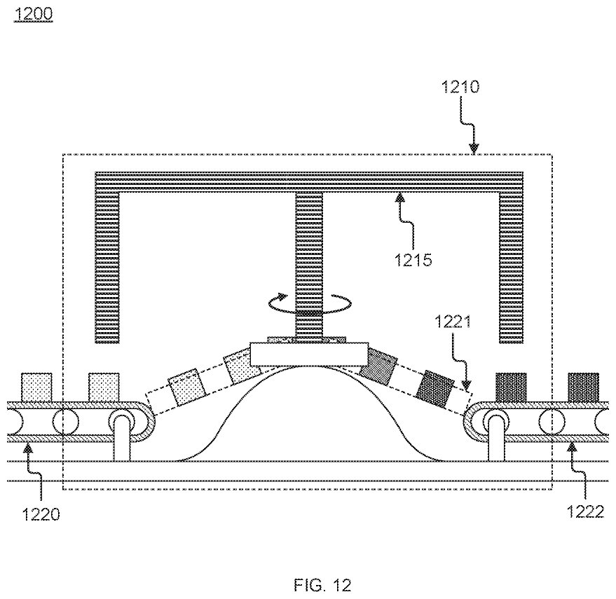

Referring now to FIG. 12, an exemplary heating device 1200 comprising a plurality of transitory mechanisms 1220, 1221, 1222 is illustrated. In some embodiments, the heating device 1200 may comprise a heating container 1210. In some aspects, the heating device 1200 may comprise a plurality of transitory mechanisms 1220, 1221, 1222.

In some embodiments, the transitory mechanism 1220 may transport one or more heated objects 1230 to the heating container 1210. In some implementations, the transitory mechanism 1221 may rotate, elevate, and/or otherwise manipulate the orientation of the heated objects 1230 to ensure even heat distribution on all sides of the heated objects 1230 simultaneously as well as maintain consistent cyclical movement through the heated device 1200. In some aspects, the transitory mechanism 1221 may comprise a variable surface such that as the transitory mechanism 1221 rotates, an inclination within the transitory mechanism 1221 may catch and retain heated objects 1230 entering the heating container 1210 via transitory mechanism 1220, while a downward sloping region of the transitory mechanism 1221 may release heated objects 1230 exiting the heating container 1210 onto transitory mechanism 1222 once the heated objects 1230 have reached at least a predetermined temperature. In some embodiments, the heating element 1215 may rotate within the heating container 1210 to distribute heat around all of the heated objects 1230 within the heating container 1210.

As an illustrative example, charcoal may be transported linearly to the entrance of the heating container 1210, where the charcoal may be received onto an inclined portion of a rotating platform. The rotating platform may rotate at a rate sufficient to allow the charcoal to be heated to a predetermined temperature. As the charcoal reaches the end of the heating container 1210, a a depression or downward slope in the rotating platform may direct the charcoal onto a final conveyor belt. In some aspects, the transitory mechanism 1222 may deposit heated objects 1230 into a collecting mechanism, such as, for example and not limitation, a collection container, for use when the heated objects 1230 have reached the predetermined temperature.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination.

Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A heating device comprising:
a heating container;
a heating element configured to heat at least one heated object, wherein the heating element is located within the heating container;
a first transitory mechanism comprising a movable platform configured to move the at least one heated object to at least one position proximate to the heating element for a predefined amount of time, allowing the at least one heated object to reach at least a predefined temperature; and
an activation mechanism logically connected to one or more of: the heating element and the first transitory mechanism, wherein the activation mechanism is configured to operate one or more of: the primary heating element and the first transitory mechanism.

2. The heating device of claim 1, wherein the first transitory mechanism is further configured to move the at least one heated object to a location away from the heating element, once the at least one heated object has reached at least the predefined temperature.

3. The heating device of claim 2, wherein the first transitory mechanism rotates.

4. The heating device of claim 1, wherein a second transitory mechanism is located proximate to one or both the heating element and the first transitory mechanism, wherein the second transitory mechanism is configured to receive and move the at least one heated object to a location away from the heating element, once the at least one heated has reached at least the predefined temperature.

5. The heating device of claim 4, wherein a third transitory mechanism is located between the first transitory mechanism and the second transitory mechanism, wherein the third transitory mechanism is configured to move the at least one heated object through the heating container for a duration that allows the at least one heated object to reach at least the predefined temperature.

6. The heating device of claim 5, wherein the third transitory mechanism rotates.

7. The heating device of claim 1, wherein the heating container further comprises a ventilation system comprising at least one opening.

8. The heating device of claim 1, further comprising at least one collecting mechanism configured to collect a plurality of heated objects.

9. The heating device of claim 8, wherein the at least one collecting mechanism is removeable.

10. The heating device of claim 8, wherein the transitory mechanism deposits the plurality of heated objects into the at least collecting mechanism.

11. The heating device of claim 1, further comprising a first door and a second door that at least temporarily enclose the heating container, wherein the first door opens and shuts when the at least one heated object enters the heating container, and the second door opens and shuts when the at least one heated object exits the heating container.

12. The heating device of claim 1, further comprising a dispensing mechanism comprising an outlet that dispenses the at least one heated object onto the first transitory mechanism.

13. The heating device of claim 12, wherein the dispensing mechanism dispenses the at least one heated object at a constant rate.

14. The heating device of claim 12, wherein the dispensing mechanism further comprises at least one sensor logically connected to a regulator that controls a speed at which the at least one heated object is dispensed.

15. The heating device of claim 1, wherein the first transitory mechanism manipulates the orientation of a plurality of heated objects by one or more of: elevating, rotating, and moving the plurality of heated objects.

16. The heating device of claim 1, wherein at least a portion of the first transitory mechanism elevates the at least one heated object toward the heating element until a predefined temperature is reached, then lowers the at least one heated object.

17. The heating device of claim 1, further comprising an external device that is communicatively coupled with the activation mechanism.

18. The heating device of claim 1, further comprising a rechargeable power source in logical communication with the activation mechanism.

19. The heating device of claim 1, wherein the heating element rotates within the heating container.

20. The heating device of claim 1, wherein the heating element raises and lowers within the heating container.
